(19) United States
(12) Patent Application Publication
(10) Pub. No.: US 2026/0288076 A1
(43) Pub. Date: Sep. 24, 2026

(54) DRIVE CONTROL DEVICE, ELECTRONIC TIMEPIECE, DRIVE CONTROL METHOD, AND STORAGE MEDIUM

(71) Applicant: CASIO COMPUTER CO., LTD., Tokyo (JP)

(72) Inventor: Mitsuaki MATSUO, Tokyo (JP)

(73) Assignee: CASIO COMPUTER CO., LTD., Tokyo (JP)

(21) Appl. No.: 19/571,270

(22) Filed: Mar. 18, 2026

(30) Foreign Application Priority Data
Mar. 24, 2025 (JP) 2025-048771

(51) Int. Cl. G04C 3/14

(52) U.S. Cl. CPC G04C 3/14

(57) ABSTRACT

A drive control device includes a processor configured to control a driver that drives a hand to rotate. The processor measures an elapsed time while a reference period elapses in a timing module that measures time, and based on the elapsed time, causes the driver to drive the hand to rotate a unit number of times per the reference period with a reference interval shorter than the reference period, the unit number of times being plural, and initializes the elapsed time each time the reference period elapses.

### BACKGROUND OF THE INVENTION

### Technical Field

The present disclosure relates to a drive control device, an electronic timepiece, a drive control method, and a storage medium.

### Description of Related Art

In an electronic timepiece including a hand(s), the position of the hand is regularly changed in accordance with time, for example, in units of a second. In such an electronic timepiece, the hand is fast-forwarded to a target position, when, for example, performing various settings, correcting time, changing local time to display, or performing functional display other than time display. JP 2015-184106 A discloses, when setting/changing local time, intermittently fast-forwarding a hand to each of positions corresponding to local time candidates.

### SUMMARY OF THE INVENTION

According to an aspect of the present disclosure, there is provided a drive control device including a processor configured to control a driver that drives a hand to rotate,
wherein the processor
   measures an elapsed time while a reference period elapses in a timing module that measures time, and based on the elapsed time, causes the driver to drive the hand to rotate a unit number of times per the reference period with a reference interval shorter than the reference period, the unit number of times being plural, and
   initializes the elapsed time each time the reference period elapses.

Further features of the present invention will become apparent from the following description of exemplary embodiments (with reference to the attached drawings).

### BRIEF DESCRIPTION OF DRAWINGS

FIG. 1 is a block diagram showing a functional configuration of an electronic timepiece of an embodiment(s).

FIG. 2A illustrates movement timings of a second hand.

FIG. 2B illustrates movement timings of the second hand.

FIG. 3 is a flowchart showing a control procedure for a sweep movement control process.

### DETAILED DESCRIPTION

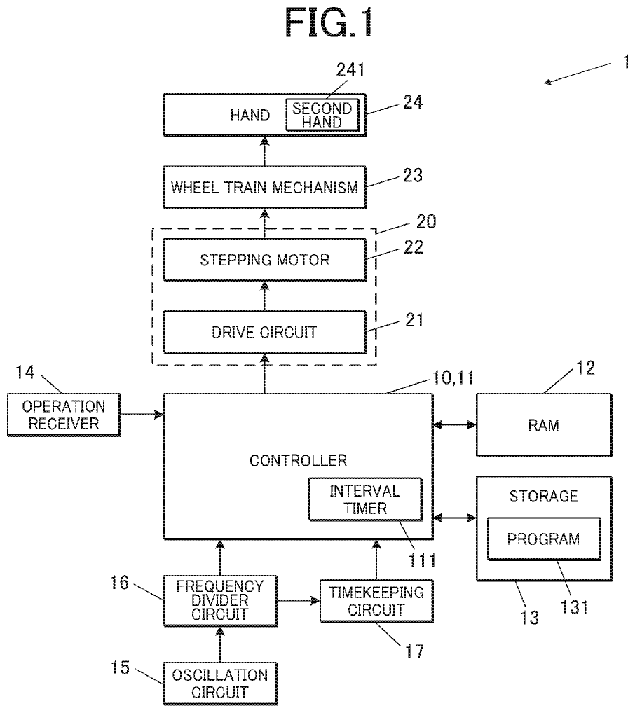

Hereinafter, one or more embodiments of the present disclosure will be described on the basis of the drawings. As shown in the block diagram of FIG. 1, an electronic timepiece 1 includes a controller 11, a random access memory (RAM) 12, a storage 13, an operation receiver 14, an oscillation circuit 15, a frequency divider circuit 16, a timekeeping circuit 17 (timing module), a drive circuit 21, a stepping motor 22, a wheel train mechanism 23, and a hand 24. The electronic timepiece 1 may be a portable electronic timepiece, such as a wristwatch.

The controller 11 has a processor that controls the overall operation of the electronic timepiece 1. The processor may be a general-purpose central processing unit (CPU), or may be a microcontroller, an integrated circuit (IC), a large-scale integrated circuit (LSI) or the like suitable for operating a timepiece. The controller 11 may have a single processor, or may have multiple processors that independently perform processes depending on the application or the like. Alternatively, the multiple processors may work together to perform processes in parallel. The controller 11 includes an interval timer 111. The interval timer 111 may not be a hardware component. Simply, the controller 11 may operate as the interval timer 111 by counting clock signals to calculate/measure the elapsed time. The interval timer 111 starts the counting/measurement in response to a trigger at a certain timing and outputs an interrupt signal when having measured a specified time. Hereinafter, this interrupt signal may be referred to as a “timer interrupt”. The controller 11 is included in a drive control device 10 of this embodiment.

The RAM 12 provides the controller 11 with a memory space for work and stores temporary data. The RAM 12 stores, for example, data of the number of movements of the hand 24 per second.

The storage 13 has a nonvolatile memory and stores programs 131, setting data, and so forth. The nonvolatile memory may be, for example, a flash memory. As long as it is usable as a nonvolatile memory, the type of nonvolatile memory is not specifically limited.

The operation receiver 14 receives input operations from the outside and outputs, to the controller 11, operation signals corresponding to the contents of the received input operations. The operation receiver 14 may have, for example, a pushbutton switch. The operation receiver 14 may also have a crown, a slide switch, and another operation mechanism.

The oscillation circuit 15 includes, for example, a quartz crystal resonator and a resonance circuit, and generates clock signals of around the resonant frequency of the quartz crystal resonator. The resonant frequency may be, for example, 32.768 kHz or 16.384 kHz. This frequency changes depending on the environmental conditions, such as temperature, in addition to the adjustment accuracy of the quartz crystal resonator. The quartz crystal resonator may be an AT-cut crystal that is stable around room temperature against temperature change. The frequency divider circuit 16 divides the frequency of the clock signals to obtain signals of an appropriate frequency and outputs the frequency-divided signals. The frequency of the frequency-divided signals may be multiple and determined in accordance with the frequency necessary for each component of the electronic timepiece 1. The frequency-divided signals may include a 1-Hz signal for measuring the date and time, i.e., a one-second (reference period) signal.

The timekeeping circuit 17 may count 1-Hz signals to obtain the current date and the current time, i.e., the date and time, in units of one second (reference period). The operation of the timekeeping circuit 17 may be included in the software operation of the controller 11. In other words, the electronic timepiece 1 may not have the timekeeping circuit 17 as a hardware component. Separate from the operation of the controller 11 as the timekeeping circuit 17, the electronic timepiece 1 may have a real time clock (RTC) as a hardware component.

The drive circuit 21 outputs drive pulses to the stepping motor 22 based on the control by the controller 11. The stepping motor 22 rotates/moves by a specific angle in response to each input drive pulse. The wheel train mechanism 23 is a gear train that converts the rotation of the stepping motor 22 into rotation of the hand 24. The hand 24 is a needle-like object used for time display, and rotates (moves or performs a rotational movement) on a plane along the display surface of the electronic timepiece 1 in response to the operation of the wheel train mechanism 23, i.e., the operation of the stepping motor 22. The hand 24 may include a second hand 241, a minute hand, and an hour hand. The hand 24 may include a hand(s) other than the second hand 241, the minute hand, and the hour hand. The other hand may have a rotation axis at a position different from that of the second hand 241, the minute hand and the hour hand. The drive circuit 21 and the stepping motor 22 correspond to a driver 20 of this embodiment.

Next, rotational movements of the hand 24 of the electronic timepiece 1 of this embodiment will be described. As described above, in the electronic timepiece 1, time is displayed by the rotations of the second hand 241, the minute hand and the hour hand. At least the second hand 241 performs the rotational movements independently of the other hands. The second hand 241, the minute hand and the hour hand may be caused to perform the rotational movements independently of one another by their respective stepping motors 22 and wheel train mechanisms 23. Alternatively, the minute hand and the hour hand may rotate in conjunction with one another. In other words, the electronic timepiece 1 may have a wheel train mechanism 23 that rotates the hour hand by a rotation angle equal to 1/12 of that of the minute hand in response to the operation of their common stepping motor 22.

The second hand 241 of the electronic timepiece 1 performs the rotational movements at intervals shorter than one second, making one revolution per minute on the display surface. The interval(s) between the rotational movements may be, for example, about 1/12 seconds. In other words, the second hand 241 may perform 12 rotational movements per second. A typical second hand, which performs one rotational movement per second, rotates six degrees at a time. In contrast, the second hand 241 of this embodiment may rotate an angle obtained by dividing six degrees by 12, i.e., 0.5 degrees, at a rotational movement. In other words, a unit angle that the second hand 241 rotates at one movement is 0.5 degrees. The rotational movements at such fine, substantially uniform intervals appear to the user to be smooth rotation, and are referred to as “sweep movement”. The minute hand and the hour hand may rotate in their typical manners. For example, the minute hand may perform one rotational movement every ten seconds, and the hour hand may perform one rotational movement every two minutes.

A typical electronic timepiece outputs a synchronization signal at the timing of each exact second, and measures time and moves a second hand (and so forth). The electronic timepiece 1 of this embodiment, in addition to the above, repeatedly measures, with the interval timer 111, the interval between the rotational movements of the second hand 241, which hereinafter may be referred to as “hand movements”, in each second, thereby determining the timing of each rotational movement of the second hand 241 other than the timing of second synchronization thereof. In other words, the electronic timepiece 1 does not raise the output frequency of synchronization signals according to the number of rotational movements of the second hand 241.

Typically, clock signal frequencies are defined by powers of two (2^{N}), which makes it impossible to precisely determine the intervals of frequency signals containing a multiple of a prime number other than 2. Higher clock frequencies can improve the accuracy of the intervals approximately. However, in the timekeeping operation of the electronic timepiece 1, raising the frequency of the frequency-divided signals is difficult from the standpoint of reducing power consumption. Therefore, when the second hand 241 is moved multiple times (unit number of times) per second (predetermined second(s)), such as in the sweep movement, a deviation occurs in the interval between the movements. As this deviation cumulates, it may reach a non-negligible magnitude. In other words, it is not always easy to obtain highly accurate signals synchronized with time of less than one second. In contrast, as a drive control method of this embodiment, the electronic timepiece 1 keeps conventional-and-accurate second synchronization signals, and determines the hand-movement timings of less than one second while synchronizing some of the hand movements and a timekeeping process with the signals. In this case, even when the hand-movement timings for the unit number of times, which is the number of rotational movements of less than one second, slightly deviate from exact reference intervals, the deviations are initialized and eliminated at the timing of a second synchronization signal. This prevents deviations in measuring time from being cumulated. Therefore, the accuracy of a time measured by the interval timer 111 may not be high as long as the intervals between the rotational movements of the second hand 241 do not appear to the user to be unnatural. In particular, even if a reference interval(s) is defined by the reciprocal of a frequency containing a multiple of a prime number other than 2, it is unnecessary to raise the frequency to improve the accuracy. Accordingly, the electronic timepiece 1 can suppress increases in manufacturing and operational costs and power consumption.

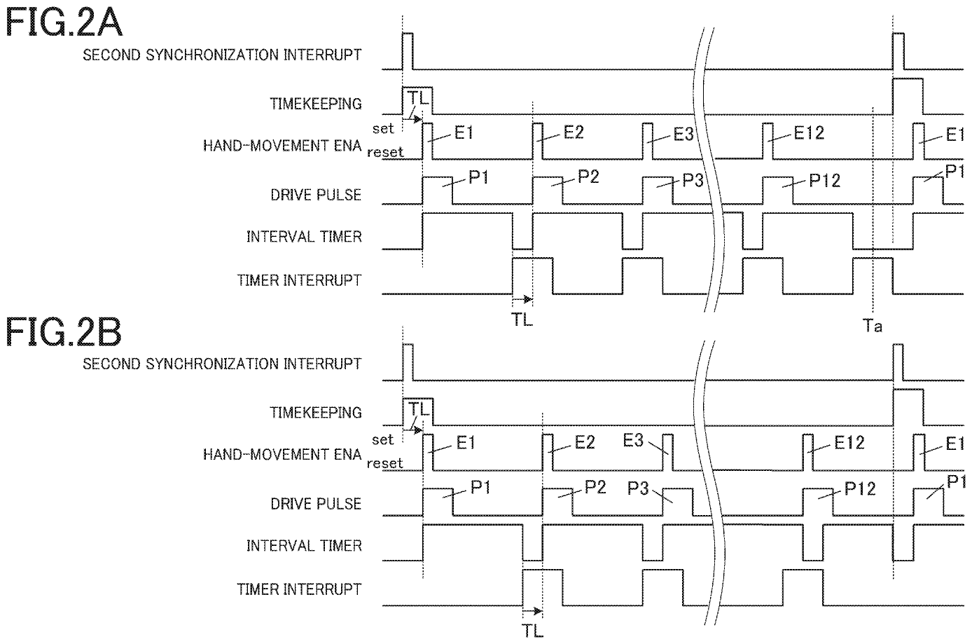

FIG. 2A and FIG. 2B illustrate timings for the sweep movement, in which the second hand 241 performs 12 rotational movements per second. In the electronic timepiece 1, the operation (movement) of the second hand 241 is controlled by an interrupt process based on second synchronization signals and an interrupt process with the interval timer 111 measuring about 1/12 seconds. When a second synchronization signal is output, an interrupt signal occurs and the timekeeping process is performed to update the current date and time. With this, a hand-movement enable signal (ENA), which enables the rotational movement of the second hand 241, is set, for example, to be a high level, and a drive pulse is output from the drive circuit 21 to the stepping motor 22. The hand-movement enable signal may be a flag set in the drive circuit 21. In synchronization with the output of this drive pulse, the interval timer 111, which measures about 1/12 seconds, starts the measurement. Although 1/12 seconds are 83.3 milliseconds, the intervals (reference intervals) at which the drive pulse is output may deviate from this as described above. For example, the reference interval(s) may be around 81 to 85 milliseconds.

It is noted that, in practice, there is a time lag TL between when an interrupt signal related to a hand movement is input and when a drive pulse is actually output. Therefore, the interval timer 111 may measure a time obtained by subtracting a time corresponding to this time lag TL from the reference interval, as a standby period before starting a process for outputting the next drive pulse. For example, the standby period may be about 80 milliseconds. When the drive pulse is output from the drive circuit 21 to the stepping motor 22 in response to the set hand-movement enable signal, the hand-movement enable signal is reset, for example, to be a low level.

When the interval timer 111 measures the standby period, an interrupt signal is output. Based on a timer interrupt related to this interrupt signal, the controller 11 sets the hand-movement enable signal, which enables the rotational movement of the second hand 241. Accordingly, the drive circuit 21 outputs the drive pulse. In other words, the first hand movement in each second is based on a second synchronization signal. The second to 12^{th} hand movements in each second are each based on a timer interrupt corresponding to the measurement by the interval timer 111. The timekeeping process may not be performed in response to the timer interrupt. In other words, the timekeeping circuit 17 may measure time in units of one second.

As shown in FIG. 2A, the controller 11 counts the number of times the hand-movement enable signal is set, i.e., the number of set times of hand-movement enable signals (E1 to E12), or the number of times the drive pulse is output, i.e., the number of output times of drive pulses (P1 to P12), in each second. The controller 11 sets no hand-movement enable signal after the 12^{th} hand-movement enable signal E12 or the 12^{th} drive pulse P12 is output in each second. If the output interval(s) (reference interval(s)) of the drive pulses is shorter than 83.3 milliseconds, after the 12^{th} drive pulse P12 is output, the 13^{th} timer interrupt occurs. The controller 11 sets no hand-movement enable signal at a timing Ta corresponding to the 13^{th} timer interrupt. Therefore, no drive signal is output from the drive circuit 21 in response to the 13^{th} timer interrupt or any subsequent timer interrupt. When one second elapses and the next second synchronization signal is input, the counted value of the number of times the hand-movement enable signal is set or the number of times the drive pulse is output is initialized to be counted again from “1”. With this, a hand-movement enable signal corresponding to that next second synchronization interrupt is set.

On the other hand, as shown in FIG. 2B, if the output interval(s) of the drive pulses is longer than 83.3 milliseconds, after the 12^{th} drive pulse P12 is output, a second synchronization interrupt accompanying a second synchronization signal occurs while the interval timer 111 is measuring the standby period. In this case, the measurement by the interval timer 111 is stopped even if it is in progress, and the counted value of the number of times the hand-movement enable signal is set or the number of times the drive pulse is output is initialized. In response to a hand-movement enable signal E1 or a drive pulse P1 based on a second synchronization interrupt, the number of times the hand-movement enable signal is set or the number of times the drive pulse is output is counted again from “1”.

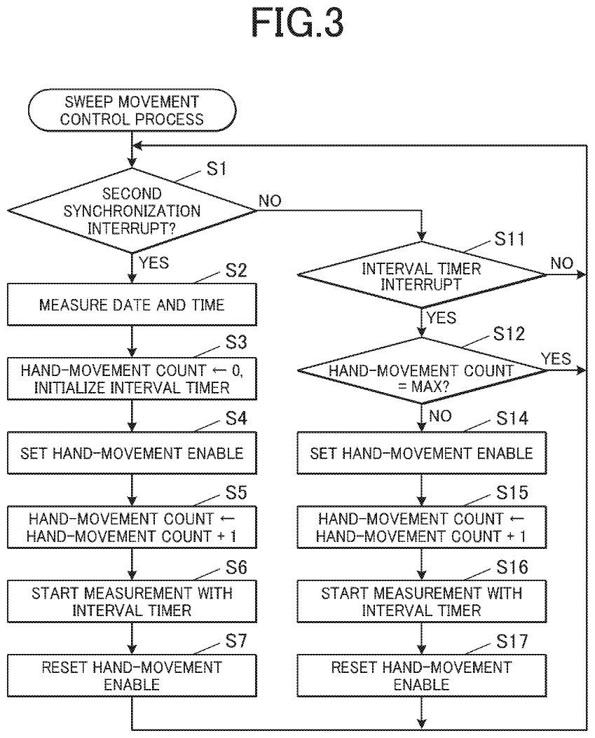

As shown in the flowchart of FIG. 3, part of the above procedure is performed as software control by the controller 11 with respect to the interrupt processes. The controller 11 determines whether there has been an interrupt signal for second synchronization (S1). If the controller 11 determines that there has been an interrupt signal for second synchronization (S1; YES), the controller 11 measures the date and time (S2). The controller 11 adds one second to the current date and time. The controller 11 initializes a hand-movement count (i.e., the number of rotational movements of the second hand 241) within a second to zero and initializes the measurement by the interval timer 111 (S3).

The controller 11 sets a hand-movement enable signal (S4). Accordingly, the drive circuit 21 outputs a drive pulse to the stepping motor 22. The controller 11 adds “1” to the hand-movement count for the second (S5). The controller 11 starts the measurement with the interval timer 111 (S6). The controller 11 resets the hand-movement enable signal (S7). The controller 11 then returns to Step S1.

If the controller 11 determines that there has been no interrupt signal for second synchronization (S1; NO), the controller 11 determines whether there has been an interrupt signal from the interval timer 111 (S11). If the controller 11 determines that there has been no interrupt signal from the interval timer 111 (S11; NO), the controller 11 returns to Step S1.

If the controller 11 determines that there has been an interrupt signal from the interval timer 111 (S11; YES), the controller 11 determines whether the hand-movement count is the maximum value MAX, “12” in this embodiment (S12). If the controller 11 determines that the hand-movement count is the maximum value MAX (S12; YES), the controller 11 returns to Step S1.

If the controller 11 determines that the hand-movement count is not the maximum value MAX (S12; NO), the controller 11 sets a hand-movement enable signal (S14). Accordingly, the drive circuit 21 outputs a drive pulse to the stepping motor 22. The controller 11 adds “1” to the hand-movement count (S15). The controller 11 starts the measurement with the interval timer 111 (S16). The controller 11 resets the hand-movement enable signal (S17). The controller 11 then returns to Step S1.

The measurement by the interval timer 111 may be started mechanically in conjunction with the output of a drive pulse to the stepping motor 22. Steps S1 to S7 and Steps S11 to S17 may be different processes that are started independently of one another with respect to their respective interrupts.

As described above, the drive control device 10 of this embodiment includes the controller 11. The controller 11 controls the operations of the drive circuit 21 and the stepping motor 22, i.e., the driver 20, that drive the hand 24, i.e., the second hand 241 in this embodiment, to perform a rotational movement, i.e., to rotate. The controller 11 measures an elapsed time with the interval timer 111 while a reference period (e.g., one second) elapses in the timekeeping circuit 17 that measures time, and based on the elapsed time, causes the driver 20 to drive the second hand 241 to perform the rotational movement a unit number of times per reference period with a reference interval (e.g., 1/12 seconds) shorter than the reference period, the unit number of times being plural (e.g., 12 times). The controller 11 initializes the elapsed time measured by the interval timer 111 each time the reference period elapses. Thus, the drive control device 10 of this embodiment does not synchronize all the movements of the second hand 241 with time measured by the timekeeping circuit 17. The drive control device 10 repeatedly determines the reference interval within the reference period to cause the second hand 241 to move at finer intervals than the reference period. Accordingly, the drive control device 10 can cause the second hand 241 to more appropriately perform the sweep movement without increasing the temporal resolution of the timekeeping process according to the fine intervals in the sweep movement. Since the movement timings of the second hand 241 are initialized every reference period, the influence of cumulated errors is reduced. Therefore, it is sufficient for the reference intervals to have a degree of accuracy not to appear to the user to be unnatural, which suppresses, in power consumption and load, increases that would be caused by setting high-accuracy intervals. Thus, the electronic timepiece 1 can simply and easily perform fine hand movements synchronized with time at a low load. In other words, in a case where control for the sweep movement, in which a hand points to time (a point in time), is performed by a method of causing a hand to move multiple times at reference intervals while a reference period elapses, the position of the hand may deviate while the hand moves multiple times at reference intervals, but the drive control device 10 of this embodiment can keep causing the second hand 241 to move in synchronization with time measured based on the reference period even when the second hand 241 points to time by the aforementioned method and the position of the second hand 241 deviates while the second hand 241 moves multiple times at reference intervals.

According to the disclosure by JP 2015-184106 A mentioned above, during the fast-forwarding of the hand, there is no need to control the movement of the hand in accordance with a reference period used for measuring time, and accordingly there is no disclosure of any hand movement control method therein. In the case where time is indicated by the method of causing a hand to move multiple times at reference intervals while a reference period elapses, the position of the hand may deviate while the hand moves multiple times at reference intervals. In contrast, the drive control device 10 of this embodiment can keep causing the second hand 241 to move in synchronization with time measured based on the reference period even when the position of the second hand 241 deviates while the second hand 241 moves multiple times at reference intervals.

Further, the controller 11, with the interval timer 111, may measure a standby period from a timing at which the driver 20 drives the second hand 241 to perform the rotational movement. After measuring the standby period, the controller 11 may output a signal to cause the second hand 241 to perform the rotational movement to the drive circuit 21 at a timing corresponding to the reference interval. Since there is a slight time lag TL from when the process of causing the second hand 241 to perform a rotational movement is started to when a drive pulse is actually output to the drive circuit 21, the time that is measured by the interval timer 111 may be slightly shorter than the reference interval. Further, since the timer measurement of the elapsed time is performed separately from the timekeeping, there is no need to take the influence of the measurement accuracy on the timekeeping process into account.

Further, after outputting the signal to cause the second hand 241 to perform the rotational movement to the drive circuit 21 the unit number of times, the controller 11 may not output the signal until a timing at which the reference period elapses in the time that the timekeeping circuit 17 measures. As described above, there is a case where although the measurement accuracy of the interval timer 111 may be low, the interval timer 111 finishes the measurement a larger number of times within the reference period, during which the signal is output the unit number of times, than the unit number of times. In such a case where the unit number of times is exceeded, the second hand 241 is not moved any further, which can reduce the possibility of occurrence of a deviation in displayed content.

Further, the controller 11 may count the number of times the signal is output, and in response to the reference period having elapsed, initialize the measurement of the standby period and the number of times the signal is output and output the signal to the drive circuit 21. Contrary to the above, there may be a case where the reference period elapses and a second synchronization signal occurs before the interval timer 111 finishes the measurement of the reference interval the unit number of times. In such a case, the controller 11 causes the second hand 241 to perform the rotational movement in response to the second synchronization signal, and also stops the measurement by the interval timer 111 to restart the measurement, thereby initializing the deviation(s) in the measurement. Thus, the drive control device 10 can easily adjust the measurement by the interval timer 111, which is a separate process from the timekeeping process. Therefore, this drive control device 10 can simply and easily cause the second hand 241 to perform the rotational movement(s) synchronized with time at a low load.

Further, the reference period may be one second, and the timekeeping circuit 17 may measure the time in units of the reference period. In other words, the drive control device 10 causes the second hand 241 to perform the rotational movement and causes the interval timer 111 to perform the measurement in synchronization with time obtained with high accuracy by the timekeeping circuit 17 as often as possible. Therefore, the drive control device 10 prevents deviations in the movement timings of the second hand 241 from being cumulated much, and can cause the second hand 241 to display time with near-perfect precision.

Further, the electronic timepiece 1 of this embodiment includes the drive control device 10 described above, the hand 24 including the second hand 241, and the driver 20 that, based on the control by the controller 11, drives the second hand 241 to perform the rotational movement by a unit angle obtained by dividing an angle corresponding to the reference period by the unit number of times. Therefore, this electronic timepiece 1 can simply and easily reduce an increase in load, and also can cause the hand 24 (second hand 241) to display time with near-perfect precision.

Further, the drive control method of this embodiment includes: (1) measuring an elapsed time while a reference period elapses in the timekeeping circuit 17 that measures time, and based on the elapsed time, causing the driver 20 to drive the hand 24 (second hand 241) to perform a rotational movement, i.e., to rotate, a unit number of times per reference period with a reference interval shorter than the reference period, the unit number of times being plural; and (2) initializing the elapsed time each time the reference period elapses. Accordingly, without increasing the temporal resolution of the timekeeping process, this drive control method can cause the second hand 241 to move at finer intervals than the temporal resolution. Since the movement timings of the second hand 241 in this case are initialized every reference period, the influence of cumulated errors is reduced. Therefore, it is sufficient for the measurement of the reference intervals to have a degree of accuracy not to appear to the user to be unnatural, which suppresses, in power consumption and load, increases that would be caused by high-accuracy measurement. Thus, the drive control method can simply and easily perform fine hand movements synchronized with time at a low load.

The present disclosure is not limited to the above embodiment, and various modifications can be made. For example, in the above, in response to a second synchronization signal at every second, a movement timing of the second hand 241 is synchronized with time, but not limited thereto. The timing to be synchronized with time may not be every second. For example, the movement timings of the second hand 241 may be synchronized with time in response to a second synchronization signal of every two seconds, i.e., once every other signal, to initialize the measurement timings of the interval timer 111, the time measured thereby, and the numerical value of the hand-movement count. In other words, it is unnecessary to initialize the measurement timings of the interval timer 111 and the numerical value of the hand-movement count in response to every second synchronization signal, which is used for updating the date and time that is measured by the timekeeping circuit 17. As long as an error(s) in reference intervals that are measured by the interval timer 111 is small, a deviation(s) in the rotational-movement timings of the second hand 241 does not become significant even if the movement timings are not synchronized with time in response to a second synchronization signal of every second. Alternatively, more broadly, the initialization may be performed in response to a second synchronization signal at a specific timing, such as a timing that comes once per minute for detecting a deviation in position of the second hand 241. Further, if the timekeeping circuit 17 measures time of less than one second in response to synchronization signals of, for example, 2 to 16 Hz, the measurement of the reference interval may be initialized in response to an appropriate number of such synchronization signals.

Further, the reference period may not be a fixed value. The reference period may be set longer for the nighttime so that a larger deviation is permitted during the nighttime than the daytime. Conversely, the reference period may be set longer for the daytime, giving priority to the hand movements at reference intervals during the daytime, and the measurement timings or the value of the reference interval(s) may be initialized in synchronization with a second synchronization signal during the nighttime mainly.

Further, the difference between the reference interval(s) and the standby period(s) may be determined as appropriate. In a case of a time lag TL that is so small that there is no need to dare to determine the difference, the interval timer 111 may measure the reference period.

Further, in the above, the sweep movement is performed by the second hand 241, but not limited thereto. The movement timings of any hand can be controlled as described above, provided that the hand can perform the rotational movements at fine time intervals while synchronizing with the passage of time, thereby performing the sweep movement. Examples of such a hand may include those used for decorative purposes.

Further, in the above, the computer-readable medium storing the program(s) 131 for the drive control of the present disclosure is the storage 13 composed of a nonvolatile memory, such as a flash memory, but not limited thereto. As the non-transitory computer-readable storage medium, another type of nonvolatile memory, such as an MRAM or an HDD, or a portable storage medium, such as a CD-ROM or a DVD disk, may be used. Further, as a medium that provides data of the programs of the present disclosure via a communication line, a carrier wave is also applicable to the present disclosure.

Further, in the above, the electronic timepiece 1 is a wristwatch, but not limited thereto. It may be another type of timepiece, such as a table clock or a pocket watch. The specific configurations/components, contents of and procedures for the processes, and so forth described in the above embodiment can be changed as appropriate without departing from the scope of the present disclosure. The scope of the present invention includes the scope of claims and their equivalents.

This application claims the benefit of Japanese Patent Application No. 2025-048771, filed Mar. 24, 2025 which is hereby incorporated by reference wherein in its entirety.

1. A drive control device comprising a processor configured to control a driver that drives a hand to rotate,
wherein the processor
measures an elapsed time while a reference period elapses in a timing module that measures time, and based on the elapsed time, causes the driver to drive the hand to rotate a unit number of times per the reference period with a reference interval shorter than the reference period, the unit number of times being plural, and
initializes the elapsed time each time the reference period elapses.

2. The drive control device according to claim 1, wherein the processor
measures a standby period from a timing at which the driver drives the hand to rotate, and
after measuring the standby period, outputs a signal to cause the hand to rotate to the driver at a timing corresponding to the reference interval.

3. The drive control device according to claim 2, wherein the processor counts a number of times the signal is output, and in response to the reference period having elapsed, initializes the measurement of the standby period and the number of times the signal is output and outputs the signal.

4. The drive control device according to claim 2, wherein after outputting the signal to the driver the unit number of times, the processor does not output the signal until a timing at which the reference period elapses in the time that the timing module measures.

5. The drive control device according to claim 1, wherein after outputting a signal to cause the hand to rotate to the driver the unit number of times, the processor does not output the signal until a timing at which the reference period elapses in the time that the timing module measures.

6. The drive control device according to claim 1,
wherein the reference period is one second, and
wherein the timing module measures the time in units of the reference period.

7. An electronic timepiece comprising:
the drive control device according to claim 1;
the hand including a second hand; and
the driver that, based on the control by the processor, drives the second hand to rotate by a unit angle obtained by dividing an angle corresponding to the reference period by the unit number of times.

8. An electronic timepiece comprising:
the drive control device according to claim 2;
the hand including a second hand; and
the driver that, based on the control by the processor, drives the second hand to rotate by a unit angle obtained by dividing an angle corresponding to the reference period by the unit number of times.

9. An electronic timepiece comprising:
the drive control device according to claim 3;
the hand including a second hand; and
the driver that, based on the control by the processor, drives the second hand to rotate by a unit angle obtained by dividing an angle corresponding to the reference period by the unit number of times.

10. An electronic timepiece comprising:
the drive control device according to claim 4;
the hand including a second hand; and
the driver that, based on the control by the processor, drives the second hand to rotate by a unit angle obtained by dividing an angle corresponding to the reference period by the unit number of times.

11. An electronic timepiece comprising:
the drive control device according to claim 5;
the hand including a second hand; and
the driver that, based on the control by the processor, drives the second hand to rotate by a unit angle obtained by dividing an angle corresponding to the reference period by the unit number of times.

12. An electronic timepiece comprising:
the drive control device according to claim 6;
the hand including a second hand; and
the driver that, based on the control by the processor, drives the second hand to rotate by a unit angle obtained by dividing an angle corresponding to the reference period by the unit number of times.

13. A drive control method for a driver that drives a hand to rotate, comprising:
measuring an elapsed time while a reference period elapses in a timing module that measures time, and based on the elapsed time, causing the driver to drive the hand to rotate a unit number of times per the reference period with a reference interval shorter than the reference period, the unit number of times being plural; and
initializing the elapsed time each time the reference period elapses.

14. The drive control method according to claim 13, further comprising:
measuring a standby period from a timing at which the driver drives the hand to rotate; and
after measuring the standby period, outputting a signal to cause the hand to rotate to the driver at a timing corresponding to the reference interval.

15. The drive control method according to claim 14, further comprising counting a number of times the signal is output, and in response to the reference period having elapsed, initializing the measurement of the standby period and the number of times the signal is output and outputting the signal.

16. The drive control method according to claim 14, further comprising, after outputting the signal to the driver the unit number of times, not outputting the signal until a timing at which the reference period elapses in the time that the timing module measures.

17. The drive control method according to claim 13, further comprising, after outputting a signal to cause the hand to rotate to the driver the unit number of times, not outputting the signal until a timing at which the reference period elapses in the time that the timing module measures.

18. The drive control method according to claim 13,
wherein the reference period is one second, and
wherein the timing module measures the time in units of the reference period.

19. A non-transitory computer-readable storage medium storing a program that causes, of a drive control device that controls a driver that drives a hand to rotate, a computer to:
measure an elapsed time while a reference period elapses in a timing module that measures time, and based on the elapsed time, cause the driver to drive the hand to rotate a unit number of times per the reference period with a reference interval shorter than the reference period, the unit number of times being plural; and
initialize the elapsed time each time the reference period elapses.

20. The non-transitory computer-readable storage medium according to claim 19, wherein the program further causes the computer to:
measure a standby period from a timing at which the driver drives the hand to rotate; and
after measuring the standby period, output a signal to cause the hand to rotate to the driver at a timing corresponding to the reference interval.

21. The non-transitory computer-readable storage medium according to claim 19,
wherein the reference period is one second, and
wherein the timing module measures the time in units of the reference period.
